(19) United States
(12) Patent Application Publication
(10) Pub. No.: US 2015/0220340 A1
(43) Pub. Date: Aug. 6, 2015

(54) TECHNIQUES FOR HETEROGENEOUS CORE ASSIGNMENT

(71) Applicants: Rajkishore BARIK, Santa Clara,, CA (US); Brian T. LEWIS, Palo Alto,, CA (US); Tatiana SHPEISMAN, Menlo Park,, CA (US)

(72) Inventors: Rajkishore Barik, Santa Clara, CA (US); Brian T. Lewis, Palo Alto, CA (US); Tatiana Shpeisman, Menlo Park, CA (US)

(21) Appl. No.: 14/129,918

(22) PCT Filed: Oct. 4, 2013
(86) PCT No.: PCT/US13/63399

§ 371 Date: Dec. 27, 2013

(51) Int. Cl. G06F 9/30; G06F 1/26; G06F 9/38

(52) U.S. Cl. CPC G06F 9/30145; G06F 9/3822; G06F 1/263

(57) ABSTRACT

Various embodiments are generally directed to techniques for assigning instances of blocks of instructions of a routine to one of multiple types of core of a heterogeneous set of cores of a processor component. An apparatus to select types of cores includes a processor component; a core selection component for execution by the processor component to select a core of multiple cores to execute an initial subset of multiple instances of an instruction block in parallel based on characteristics of instructions of the instruction block, and to select a core of the multiple cores to execute remaining instances of the multiple instances of the instruction block in parallel based on characteristics of execution of the initial subset stored in an execution database; and a monitoring component for execution by the processor component to record the characteristics of execution of the initial subset in the execution database. Other embodiments are described and claimed.

### TECHNICAL FIELD

Embodiments described herein generally relate to assignment of instances of a block of instructions to cores of processor components having heterogeneous sets of cores.

### BACKGROUND

It is becoming commonplace to employ processor components incorporating heterogeneous sets of cores in computing devices. In particular, it is becoming commonplace to incorporate processor components that combine so-called “general purpose” cores alongside cores that are more specialized for graphics processing and/or other operations. Although prior practice has been to execute the majority of routines on general purpose cores and reserve more specialized cores for specific types of routines, there have proven to be benefits of allowing portions of numerous types of routines to be executed on a mixture of different types of cores.

However, doing so requires determinations of which blocks of instructions of a routine are to be executed by which ones of the different types of cores among a heterogeneous set of cores of such a processor component. Prior efforts at making such selections have included performing “practice runs” of sets of selected instructions and/or of compiled routines with practice data sets to observe the execution of various instructions by different cores. The results of such practice runs are analyzed, and the results of such analysis then serve as the basis for determining which portions of a routine are to be executed by which type of core.

However, it is typically the case that such practice runs, especially those employing practice data sets, beget results that diverge from what occurs when actual routines are executed with actual data sets. While, under some circumstances, the degree of such divergence may be regarded only as a loss of opportunity for some degree of optimization, even a small degree of such divergence can become significant for portions of routines that are executed with considerable frequency.

For portions of routines that perform a frequently used function (e.g., a frequently used routine of a library), or for portions of routines that are executed in many instances in parallel (e.g., a loop performed hundreds, thousands, or even more times), a loss of an opportunity for even a small degree of optimization can quickly become significant. The results of such a loss of opportunity may include a significant loss of available processing resources to perform other tasks and/or a significant unnecessary additional drain of limited available power in portable devices.

### BRIEF DESCRIPTION OF THE DRAWINGS

FIG. 1 illustrates an embodiment of a heterogeneous core processing system.

FIG. 2 illustrates an alternate embodiment of a heterogeneous core processing system.

FIGS. 3-6 each illustrate a portion of an embodiment of a distributed processing system.

FIGS. 7-9 each illustrate a logic flow according to an embodiment.

FIG. 10 illustrates a processing architecture according to an embodiment.

### DETAILED DESCRIPTION

Various embodiments are generally directed to techniques for assigning instances of blocks of instructions of a routine to one of multiple types of core of a heterogeneous set of cores of a processor component. More specifically, where numerous instances of a block of instructions of a routine are to be executed in parallel, determinations are made during execution of the routine of which core(s) of multiple cores of multiple types of a processor component are to be selected to execute those numerous instances. Data indicating characteristics of the instructions of the instruction block observed during compiling of the routine and/or observed during previous execution of instances of the instruction block are employed in determining the selection of core(s). Alternatively or additionally, an indication of a selected balance between execution time and power consumption is employed in determining the selection of core(s).

During compilation of the routine, at least the instruction block may be compiled for execution by more than one of the types of cores of a processor component. Also, characteristics of the instructions making up the instruction block may be recorded as characteristics data to accompany the compiled form of the routine. The characteristics so recorded may include an indication of degree of use of memory access instructions and/or of branch instructions within the instruction block. More specifically, the characteristics data may indicate what proportion of the instructions within the instruction block are memory access instructions and/or what proportion of the instructions are branch instructions (e.g., one or more of jump instructions, call instructions, return instructions, goto instructions, etc.).

During an initial execution of the routine, such recorded characteristics of the instructions within the block of instructions indicated within the characteristics data may be employed in an initial selection of one or more types of cores of the processor component to execute an initial subset of the instances of the instruction block that are to be executed in parallel. The term “initial execution” as used herein refers to an execution of the routine by the processor component for the first time such that there is no previously recorded data concerning characteristics of execution of instances of the instruction block.

During execution of the initial subset of instances, characteristics of the execution of the initial subset of instances by whatever core(s) are selected in the initial selection are recorded as part of an execution database to be referred to in subsequent executions of instances of the instruction block. The characteristics so recorded may include an indication of time required by a core to execute an instance of the instruction block and/or amount of electrical energy consumed by a core to execute that instance. A monitoring unit of the processor component may be employed to monitor various aspects of the execution of instances of the instruction block, including time required and/or electrical energy consumed per execution of an instance. Such recorded characteristics of the execution of the initial subset may be employed in a selection of one or more types of cores of the processor component to execute the remainder of the instances of the instruction block. Further, an indication of a selected balance between reducing execution time and reducing power consumption may be employed along with the recorded characteristics of execution of the initial subset of instances in making the selection of one more types of cores to execute the remainder of the instances. During execution of the remainder of the instances, more recording of characteristics of the execution of instances may occur and may be averaged together with the earlier recorded characteristics of execution of the initial subset of instances to further refine the recorded characteristics.

In some embodiments, the recorded characteristics of earlier executions of instances of the block of instructions (including the initial execution) may be employed in selecting one or more types of cores of the processor component to execute all instances of the instruction block as part of every subsequent execution of the routine. Thus, unlike the initial execution of the routine, there would be no initial selection for a subset of the instances followed by another selection for the remainder of the instances. Again, an indication of a selected balance between reducing execution time and reducing power consumption may also be employed in making the selection of types of cores. During execution, more recording of characteristics of the execution of instances by whatever core(s) were selected may occur and may be averaged together with the earlier recorded characteristics from earlier executions to further refine the recorded characteristics.

In other embodiments, during subsequent executions of the routine, there continues to be an initial selection of types of cores to execute an initial subset of instances of the block of instructions followed by a selection of types of cores to execute the remainder of the instances in a manner not unlike the initial execution. The continued use of an initial selection of types of cores for an initial subset in subsequent executions may be deemed desirable to provide an opportunity to detect instances where the conditions of execution are sufficiently different from those one or more previous executions that selections of types of cores may need to be changed. In other words, previous executions for which characteristics were recorded may have occurred under conditions that substantially differ from conditions of a new execution of the routine. As a result, reliance on the recorded characteristics of execution of instances of the instruction block from previous executions of the routine may lead to a significantly suboptimal selection of types of cores for the conditions of a new execution.

Thus, in such other embodiments, the recordation of characteristics of execution of instances of the instruction block in the execution database may be paired with indications of the conditions for at least some of the previous executions of the routine. Further, the initial selection may be based on the characteristics data indicating characteristics of the instructions of the instruction block observed at the time the block of instructions was compiled. In other words, the manner in which the initial selection is made may be the same across all executions, including the initial execution. The observed characteristics of current conditions may then be used to search for and retrieve recorded characteristics of previous executions occurring under substantially the same conditions. A threshold data may specify a threshold of difference in conditions that determines whether conditions between different executions are to be considered substantially the same such that they are deemed to match. Where recorded characteristics of a previous execution of the routine under substantially similar conditions is able to be found in the execution database, those recorded characteristics may serve as the basis under which a selection of types of cores for execution of the remainder of instances is determined.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general purpose computer. The required structure for a variety of these machines will be apparent from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

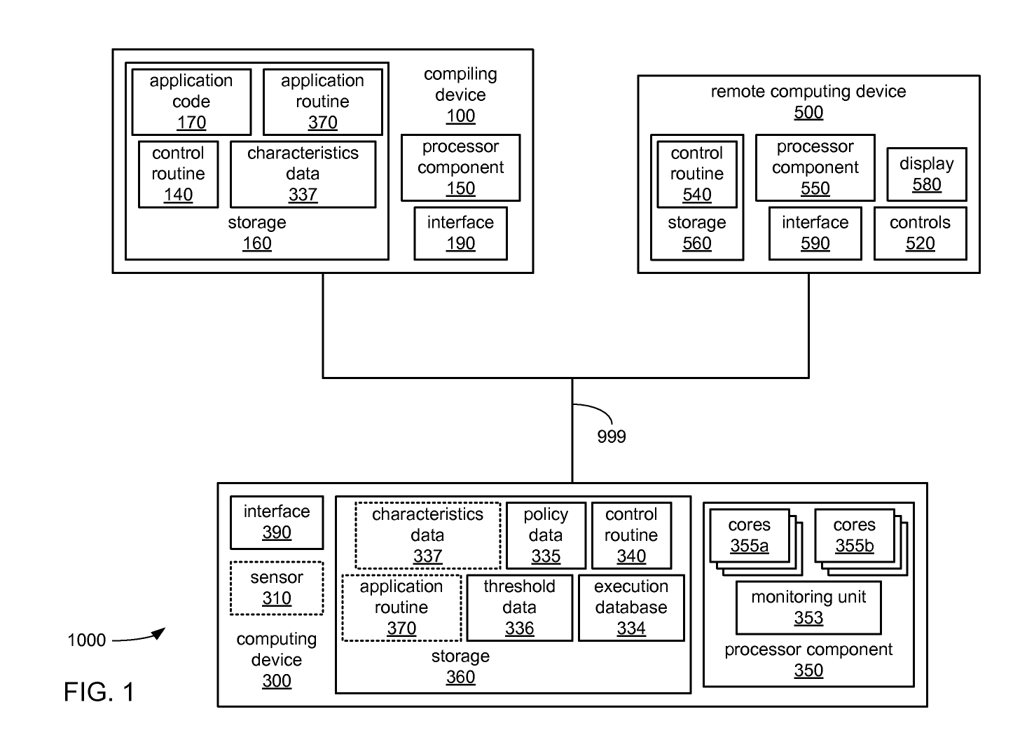

FIG. 1 is a block diagram of an embodiment of a heterogeneous core processing system 1000 incorporating one or more of a compiling device 100, a computing device 300 and a remote computing device 500. Each of these computing devices 100, 300 and 500 may be any of a variety of types of computing device, including without limitation, a desktop computer system, a data entry terminal, a laptop computer, a netbook computer, a tablet computer, a handheld personal data assistant, a smartphone, a digital camera, a body-worn computing device incorporated into clothing, a computing device integrated into a vehicle (e.g., a car, a bicycle, a wheelchair, etc.), a server, a cluster of servers, a server farm, etc.

As depicted, subsets of these computing devices 100, 300 and 500 exchange signals associated with the compilation of an application code 170 and/or the execution of an application routine 370 via a network 999. However, one or more of these computing devices may exchange other data entirely unrelated to such compiling or execution with each other and/or with still other computing devices (not shown) via the network 999. In various embodiments, the network 999 may be a single network possibly limited to extending within a single building or other relatively limited area, a combination of connected networks possibly extending a considerable distance, and/or may include the Internet. Thus, the network 999 may be based on any of a variety (or combination) of communications technologies by which signals may be exchanged, including without limitation, wired technologies employing electrically and/or optically conductive cabling, and wireless technologies employing infrared, radio frequency or other forms of wireless transmission.

In various embodiments, the computing device 300 incorporates one or more of a processor component 350, a storage 360, a sensor 310 and an interface 390 to couple the computing device 300 to the network 999. The storage 360 stores one or more of a control routine 340, the application routine 370, characteristics data 337, policy data 331, threshold data 336 and an execution database 334. The processor component 350 incorporates a heterogeneous set of cores, including at least cores 355a and 355b. Stated differently, the processor component 350 incorporates cores of multiple different types of which the cores 355a and 355b are two of such different types. The processor component 350 may also incorporate a monitoring unit 353.

It should be noted that although two different types of cores (e.g., the cores 355a and 355b) are specifically depicted, other embodiments are possible in which the processor component 350 incorporates more than two different types of cores. As previously discussed, one of the types of cores may be a “general purpose” processing core, and one of the other types of cores may be a specialized type, including and not limited to, a graphics processing core. It should also be noted that although the processor component 350 is depicted as if it were a single device (e.g., depicted with a single box) embodiments are possible in which the processor component 350 is made up of multiple semiconductor dies within a single package or spread across multiple packages interconnected with various conductors. Further, such variations in physical implementation of the processor component 350 may result in the monitoring unit 353 incorporating more than one piece of monitoring circuitry to monitor the execution of routines by the ones of the cores 355a and/or 355b. By way of example, there may be at least one of such monitoring circuitry incorporated into each semiconductor die in embodiments in which the processing component 350 incorporates multiple semiconductor dies.

In various embodiments, the compiling device 100 incorporates one or more of a processor component 150, a storage 160 and an interface 190 to couple the compiling device 100 to the network 999. The storage 160 stores one or more of a control routine 140, the application code 170, the application routine 370 and characteristics data 337. The control routine 140 incorporates a sequence of instructions operative on the processor component 150 in its role as a main processor component of the submission device 100 to implement logic to perform various functions.

In executing the control routine 140, the processor component 150 compiles the application code 170 to generate the application routine 370. The application code 170 incorporates a sequence of instructions that are meant, once compiled, to be operative on the processor component 350 of the computing device 300, to implement logic to perform various functions. The application routine 370 incorporates a sequence of instructions equivalent to the sequence of instructions of the application code 170, but in compiled form operative on the processor component 350 to implement the same logic. Due to the incorporation of more than one type of core by the processor component 350, the control routine 140 employs more than one compiler in generating the application routine 370 from the application code 170.

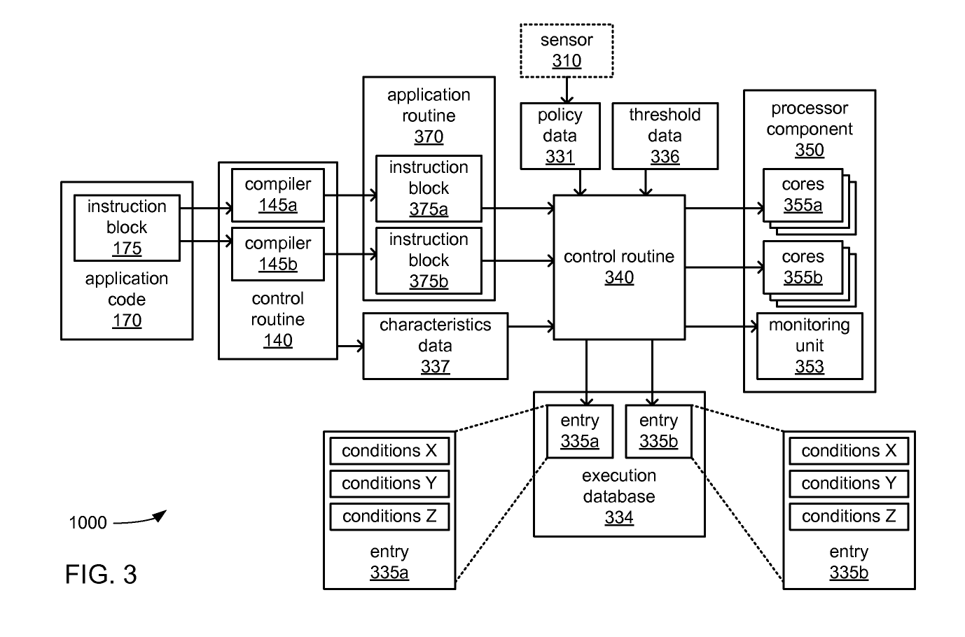

FIG. 3 depicts an embodiment of such use two compilers, specifically compilers 145a and 145b in compiling the application code 170 to generate the application routine 370. More specifically, the application code 170 incorporates an instruction block 175 that includes a sequence of instructions meant to be executed by the processor component 350 in multiple instances in parallel. By way of example, the instruction block 175 may incorporate a loop of instructions of which numerous instances (e.g., tens, hundreds, thousands, or more instances) are to be executed by the cores 355a and/or 355b of the processor component 350 in parallel. In compiling at least the instruction block 175, the compiler 145a generates the instruction block 375a for execution by one or more of the cores 355a of the processor component 350, and the compiler 145b generates the instruction block 375b for execution by one or more of the cores 355b. Each of the instructions blocks 375a and 375b implement the same logic as the instruction block 175, but each is meant to be executed by a different one of the different types of processor cores 355a and 355b, respectively.

In further executing the control routine 140, the processor component 150 analyzes the instructions making up the instruction block 175, and stores indications of characteristics of those instructions as at least part of the characteristics data 337. Again, the characteristics so recorded may include an indication of degree of use of memory access instructions and/or of branch instructions within the instruction block. More specifically, the characteristics data may indicate what proportion of the instructions within the instruction block are memory access instructions and/or what proportion of the instructions are branch instructions (e.g., one or more of jump instructions, call instructions, return instructions, goto instructions, etc.). Such proportions may be expressed as a memory-to-computation ratio equal to the quantity of memory access instructions divided by the total quantity of instructions of the instruction block, and a control-to-computation ratio equal to the quantity of branch instructions divided by the total quantity of instructions of the instruction block. Following the generation of the application routine 370 and the characteristics data 337 from the application code 170, the processor component 150 may operate the interface 190 to transmit both via the network to the computing device 300.

The control routine 340 incorporates a sequence of instructions operative on the processor component 350 in its role as a main processor component of the computing device 300 to implement logic to perform various functions. In executing the control routine 340, the processor component 350 determines which of the types of the cores 355a or 355b to assign to perform what may be numerous instances of the logic of the instruction block 175, as compiled as the instruction blocks 375a and 375b, respectively. Given that the instruction blocks 375a and 375b were specifically compiled to be operative on the cores 355a and 355b, respectively, the selection of which of the types of core 355a and 355b to assign to execute those instances necessarily results in a selection to execute one or both of the instruction blocks 375a or 375b. Stated differently, where one or more of the cores 355a are selected to execute instances of the instruction block 175, its compiled form operative on the cores 355a, namely the instruction block 375a, is selected. Correspondingly, where one or more of the cores 355b are selected to execute instances of the instruction block 175, its compiled form operative on the cores 355b, namely the instruction block 375b, is selected.

In various embodiments, various combinations of the characteristics data 337, the policy data 331 and the execution database 334 are employed by the processor component 350 in determining which types of the cores 355a and/or 355b to assign to perform instances of the instruction blocks 375a and/or 375b. The execution database 334 may maintain indications of characteristics of the execution of instruction blocks of multiple routines by different ones of the types of cores 355a and 355b. Thus, during execution of the application routine 370, the processor component 350 monitors the monitoring unit 353 and records indications of various characteristics of the execution of instances of one or both of the instruction blocks 375a and 375b. The characteristics of execution of instances by one or more of the cores 355a are stored as part of the entry 335a of the execution database 334, and characteristics of execution of instances by one or more of the cores 355b are stored as part of the entry 335b.

What characteristics of the execution are recorded in the execution database 334 depends at least partly on the capabilities of the monitoring unit 353. In various embodiments, the monitoring unit 353 may be capable of monitoring one or more of a number of clock cycles of the cores 355a and/or 355b to execute one or more specific instructions, the utilization (or lack thereof) of one or more registers of the processor component 350, cache hit and/or miss rates, rates of occurrences of one or more specific instructions, levels of electric current and/or voltage for each of the cores 355a and/or 355b, etc. In some embodiments, the indications of characteristics of execution stored as the entries 335a and 335b may include one or both of a running average of time required to execute each instance and electric power consumed to execute each instance by ones of the cores 355a and 355b, respectively.

Following compilation of the application code 170 to generate the application routine 370 and the characteristics data 337 where the application routine 370 has not previously been executed by the processor component 350, the entries 335a and 335b may not yet exist within the execution database 334 or may not yet include any indication of execution characteristics. In such situations, the processor component 350 may employ the characteristics data 337, and not either of the execution database 334 or the policy data 331 in determining which types of the cores 355a and/or 355b to assign to execute instances of the logic of the instruction block 175. This selection may be an initial selection applied to only an initial subset of the instances to be executed as part of executing the application routine 370 to provide an opportunity to observe characteristics of the execution of that initial subset of instances by whichever one(s) of the cores 355a and/or 355b are selected. Thus, an initial selection of type(s) of the cores 355a and/or 355b is made based on which is deemed to be capable of more efficiently performing the logic of the instruction block 175 based on the indications in the characteristics data 337 of the characteristics of the instructions therein.

As a result of the execution of the initial subset of instances, there then exists indications of characteristics of execution of those instances in the entries 335a and 335b of the execution database 334. The processor component 350 employs these indications from the entries 335a and 335b in determining anew which of the types of the cores 355a and/or 355b to assign to execute the remaining instances as part of continuing this initial execution of the application routine 370. It should be noted that it is possible for the types of the cores 355a and/or 355b selected to execute the initial subset of instances and to execute the remaining instances to be either the same type(s) or different type(s). In other words, it may be that one or more of the cores 355a are selected to be the type of core to execute both the initial subset of instances and the remaining instances, despite the different bases on which the selections for each are made. And, it may be that one or more of the cores 355a are selected to be the type of core to execute the initial subset of instances, while one or more of the cores 355b are selected to be the type of core to execute the remaining instances.

Again, the data in the entries 335a and 335b may include indications of time required and power consumed in each execution of an instance of the instruction blocks 375a and 375b, respectively, enabling this new determination to be made based on these observed time and power consumption characteristics combined with an indication of a selected energy policy from the policy data 331. The indication of a selection of energy policy, as previously discussed, may include an indication of a selected balance between time required to execute an instance and amount of electric power consumed to execute an instance. In some embodiments, this indication may take the form of a numerical value within a range of 0 to 1, in which 0 indicates a choice to reduce time for execution without regard to power consumed, and 1 indicates a choice to reduced the consumption of power without regard to how much time execution requires. This numerical value may be used to provide weighting values by which the indications of time required and power consumed per execution of an instance for each of the types of cores 355a and 355b are multiplied. The resulting weighted values for each of the types of cores 355a and 355b are then compared as part of selecting which type(s) of the cores 355a and 355b are to be assigned to execute the remaining instances.

Regardless of the exact manner in which the selection of types of cores for executing the remaining instances is performed, characteristics of the execution of the remaining instances are used to refine the indications of characteristics of execution already within the entries 335a and 335b. In embodiments in which the characteristics of execution of instances are stored in the entries 335a and 335b as running averages (e.g., of time required and/or power consumed for each execution of an instance), newer data may be averaged into the running averages. Further, weighting may be employed to bias the running averages towards more recent data.

In some embodiments, the indication of a selection of energy policy of the policy data 331 may be provided by an operator of one or more of the computing devices 100, 300 and 500. In other embodiments, this indication may be dynamically provided by the sensor 310, which may detect one or more conditions that triggers a change in selection of energy policy. By way of example, the sensor 310 may detect a level of power remaining in a battery, may detect the availability (or lack thereof) of AC mains power, etc., that may serve as a trigger to dynamically change the energy policy. In particular, where a level of available power remaining in a battery falls below a selected threshold, the processor component 350 may alter the policy data 331 to reflect a change in energy policy from a selected balance favoring reducing time to execute instances of the instruction blocks 375a and/or 375b, to a selected balance favoring reducing electric power consumed to execute instances.

In some embodiments, following the initial execution of the application routine 370, the processor component 350 may employ only the execution database 334 and the policy data 331 in selecting types of the cores 355a and/or 355b to execute instances of the instruction blocks 375a and/or 375b in all future executions of the applications routine 370. In such embodiments, characteristics of the execution of instances of the instruction blocks 375a and/or 375b in each future execution of the applications routine 370 are incorporated into the entries 335a and 335b, respectively, to continue to further refine the indications of characteristics in those entries. In embodiments in which the entries 335a and 335b incorporate running averages of values such as time required to execute an instance and/or power consumed to execute an instance, corresponding values from newly executed instances may be averaged into the running averages with weighting values applied to bias the running averages towards the more recent values.

In other embodiments, each of the entries 335a and 335b may be further divided into entries in which values indicative of characteristics of execution of the instruction blocks 375a and/or 375b under different conditions are separately maintained. The different conditions may include, but are not limited to, differences in the balance selected between time required and energy consumed, differences in characteristics of data and/or other inputs to whatever process is implemented in the logic of the instruction block 175, observed differences in branches taken in one or more conditional branches associated with the instruction block 175, etc. An indication of a degree of difference required to deem the conditions for one execution of the application routine 370 to be different enough from another execution to be allocated a separate entry.

In such other embodiments, if a particular difference in conditions is of a type that is able to be detected in advance of selecting types of cores (e.g., differences in selection of balance between time required and power consumed, etc.), then the processor component 350 may first check the execution database 334 for an entry associated with conditions found to be a close enough match in view of the threshold of the threshold data 336. If such an entry is found, the processor component 350 may employ the characteristics of execution indicated in that entry, along with the indication of balance between power consumption and execution time indicated in the policy data 331, to select types of the cores 355a and/or 355b to execute instances of the instruction blocks 375a and/or 375b, respectively. However, if no such entry is found, then the processor 350 may revert to the approach to selecting types of cores employed in the initial execution of the application routine 370. Specifically, the processor component 350 may make an initial selection of types of cores to execute an initial subset of the instances to be executed based on the characteristics data 337. Then, the processor component 350 may employ the characteristics of execution observed from executing the initial subset along with the energy policy indicated in the policy data 331 to select types of cores to execute the remaining instances. Further, the observed characteristics of execution of these instances under may be added to the execution database 334 in a new entry associated with the conditions under which their execution occurred.

However, in such other embodiments, if a particular difference in conditions is of a type that cannot be detected in advance of selecting types of cores (e.g., differences in characteristics of data and/or other inputs to whatever process is performed by the instruction block 375a and/or 375b), then the processor component 350 may make an initial selection of types of cores to execute an initial subset of the instances to be executed based on the characteristics data 337. The processor component 350 may then analyze observed characteristics of the execution of the initial subset to derive an indication of current conditions and then check the execution database 334 for an entry associated with conditions found to be a close enough match in view of the threshold of the threshold data 336. Again, if such an entry is found, the processor component 350 may employ the characteristics of execution indicated in that entry, along with the indication of balance between power consumption and execution time indicated in the policy data 331, to select types of the cores 355a and/or 355b to execute instances of the instruction blocks 375a and/or 375b, respectively. However, if no such entry is found, then again the processor 350 may revert to the approach to selecting types of cores employed in the initial execution of the application routine 370, and add a new entry to the execution database 334 for the observed characteristics of execution of these instances associated with the conditions under which their execution occurred.

Returning to FIG. 1, in various embodiments, the remote computing device 500 (if present) incorporates one or more of a processor component 550, a storage 560, controls 520, a display 580 and an interface 590 to couple the remote computing device 500 to the network 999. The storage 560 stores a control routine 540. The control routine 540 incorporates a sequence of instructions operative on the processor component 550 in its role as a main processor component of the remote computing device 500 to implement logic to perform various functions.

In some embodiments, the computing device 300 may be one of multiple computing devices that may be used to provide various services (e.g., as part of server farm providing email and/or website hosting, telecommunications and/or video conferencing support, support for online commerce and/or financial transactions, etc.) via the network 999 to other computing devices, such as the remote computing device 500. Thus, in executing the control routine 540, the processor component 550 may monitor the controls 520 for indications of manual input by an operator, operate the display 580 to visually present a visual portion of a user interface, and/or operate the interface 590 to enable the operator to interact with the computing device 300 through the remote computing device 500. In this way, the operator of the remote computing device 500 is able to make use of whatever services may be provided by the computing device 300.

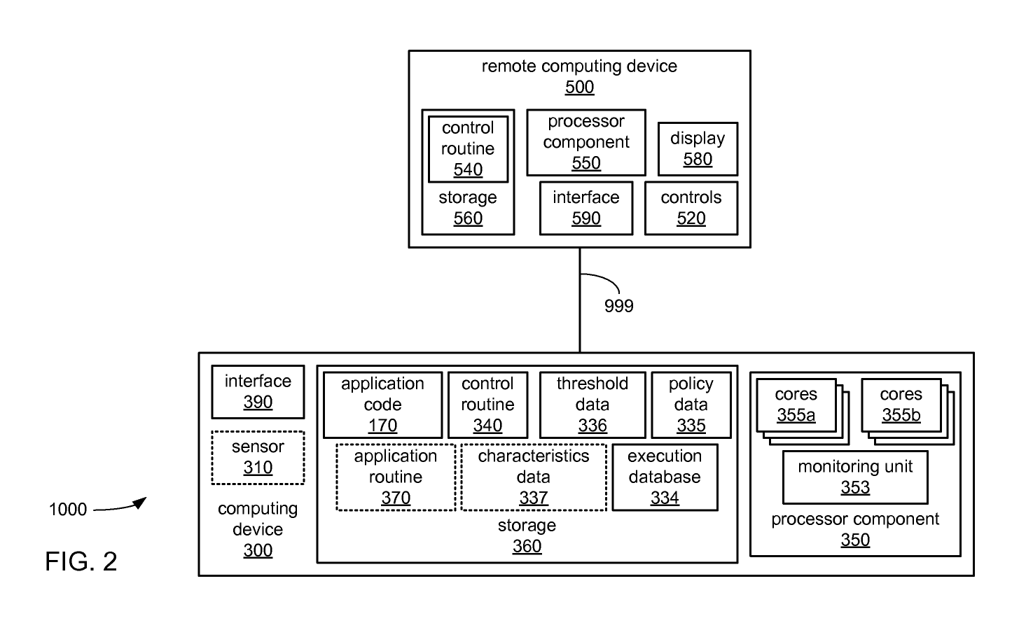

FIG. 2 illustrates a block diagram of an alternate embodiment of the heterogeneous core processing system 1000 that includes an alternate embodiment of the computing device 300. The alternate embodiment of the rendering system 1000 of FIG. 2 is similar to the embodiment of FIG. 1 in many ways, and thus, like reference numerals are used to refer to like components throughout. However, unlike the computing device 300 of FIG. 1, the computing device 300 of FIG. 2 incorporates features of the compiling device 100 of FIG. 1. Thus, it is the processor component 350 of the computing device 300 of FIG. 2 that compiles the application code 170 to generate the application routine 370 and the characteristics data 337 in lieu of there being the distinctly separate compiling device 100 to do so.

In various embodiments, each of the processor components 150, 350 and 550 may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are in some way linked.

In various embodiments, each of the storages 160, 360 and 560 may be based on any of a wide variety of information storage technologies, possibly including volatile technologies requiring the uninterrupted provision of electric power, and possibly including technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, each of the interfaces 190, 390 and 590 may employ any of a wide variety of signaling technologies enabling computing devices to be coupled to other devices as has been described. Each of these interfaces may include circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

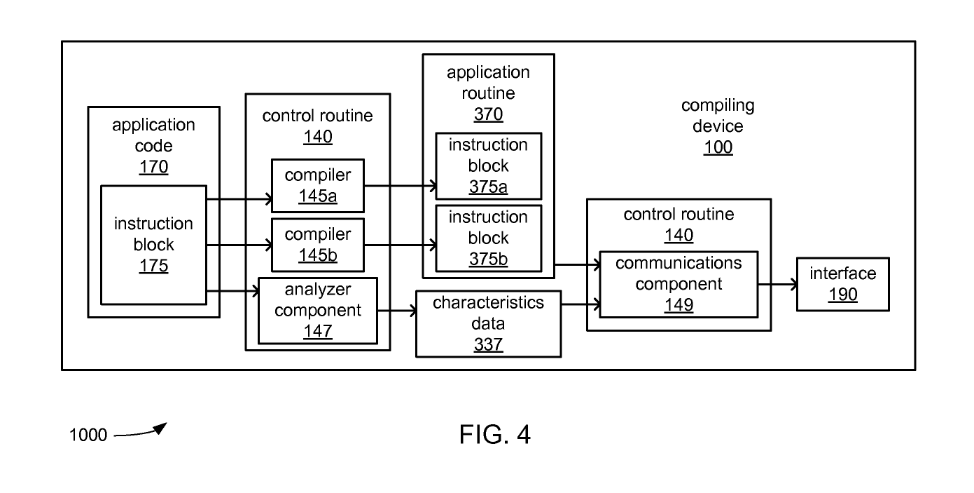

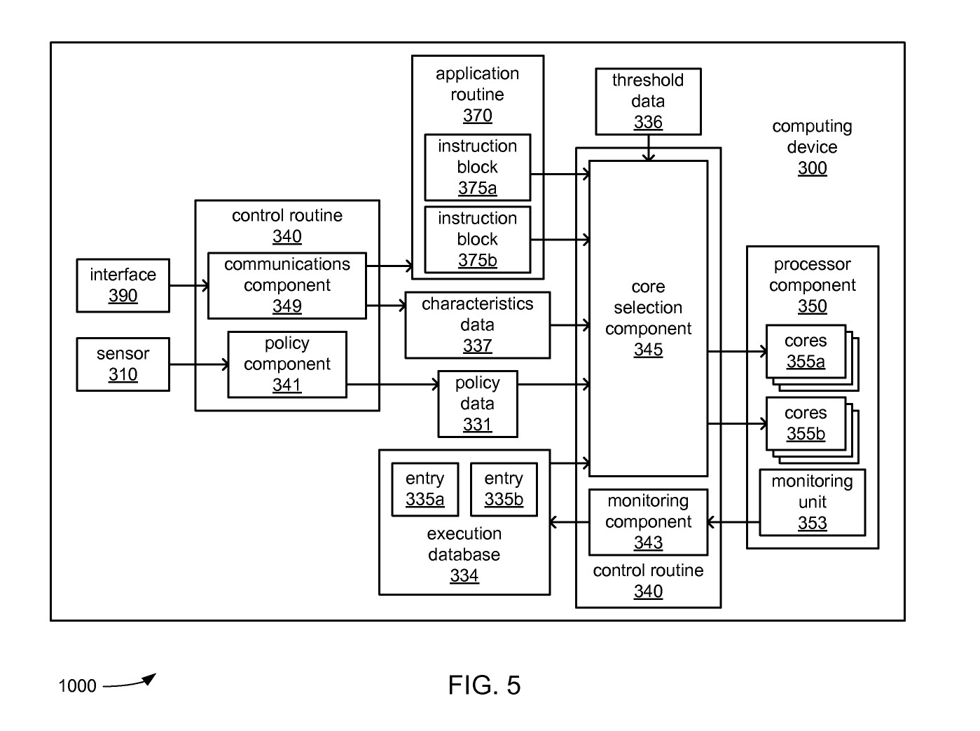

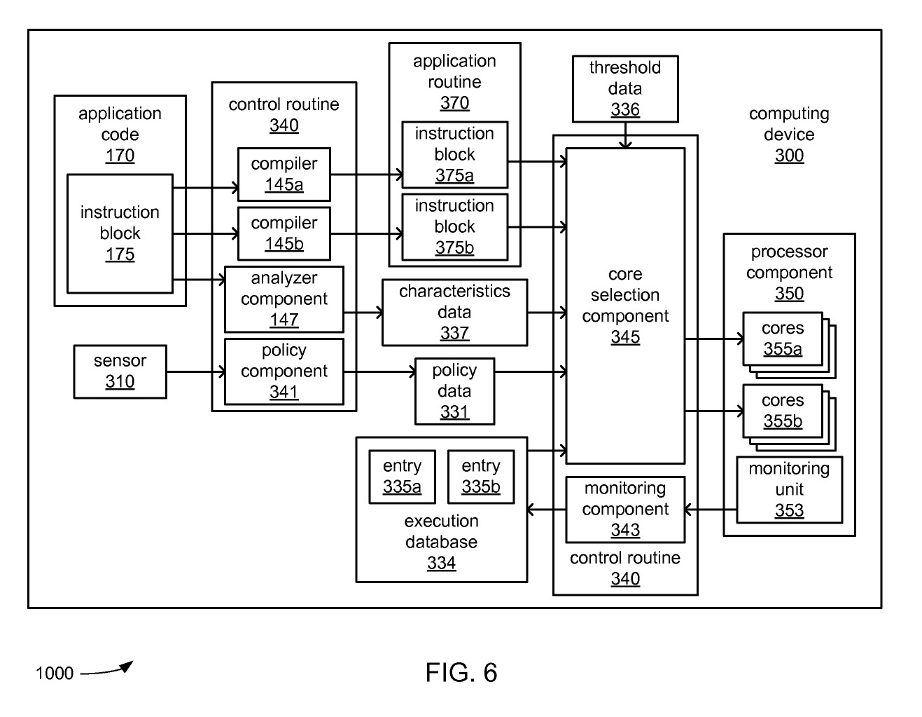

FIGS. 4 and 5 each illustrate a block diagram of a portion of an embodiment of the heterogeneous core processing system 1000 of FIG. 1 in greater detail. FIG. 6 illustrates a block diagram of a portion of an embodiment of the heterogeneous core processing system 1000 of FIG. 2 in greater detail. More specifically, FIG. 4 depicts aspects of the operating environment of the compiling device 100 in which the processor component 150, in executing the control routine 140, compiles the application code 170 to generate the application routine 370 and the characteristics data 337. FIG. 5 depicts aspects of the operating environment of one embodiment of the computing device 300 in which the processor component 350, in executing the control routine 340, selects types of the cores 355a and/or 355b to execute instances of the instruction block 375a and/or 375b, respectively. FIG. 6 depicts aspects of the operating environment of an alternate embodiment of the computing device 300 in which the processor component 350, in executing the control routine 340, additionally compiles the application code 170.

As recognizable to those skilled in the art, the control routines 140, 340 and 540, including the components of which each is composed, are selected to be operative on whatever type of processor or processors that are selected to implement applicable ones of the processor components 150, 350 or 550. In various embodiments, each of the control routines 140, 340 and 540 may include one or more of an operating system, device drivers and/or application-level routines (e.g., so-called “software suites” provided on disc media, “applets” obtained from a remote server, etc.). Where an operating system is included, the operating system may be any of a variety of available operating systems appropriate for whatever corresponding ones of the processor components 150, 350 or 550. Where one or more device drivers are included, those device drivers may provide support for any of a variety of other components, whether hardware or software components, of corresponding ones of the computing devices 100, 300 or 500.

Each of the control routines 140 or 340 may include a communications component 149 or 349 executable by the processor component 150 or 350 to operate the interface 190 or 390, respectively, to transmit and receive signals via the network 999 as has been described. Among the signals received may be signals conveying the application code 170 and/or the characteristics data 337 among one or more of the computing devices 100, 300 and/or 500 via the network 999. As will be recognized by those skilled in the art, these communications components are selected to be operable with whatever type of interface technology is selected to implement corresponding ones of the interfaces 190 and 390. Correspondingly, the control routine 540 may also include a communications component (not shown) executable by the processor component 550 to operate the interface 190 to also exchange such data and routines via the network 999.

Turning more specifically to FIG. 4, the control routine 140 may include the compilers 145a and 145b executable by the processor component 150 to compile at least the instruction block 175 of the application code 170 into the instruction blocks 375a and 375b for execution by the different types of cores 355a and 355b, respectively, of the processor component 350. Again, it should be noted that since only two types of core 355a and 355b are depicted within the processor component 350, only the two corresponding compilers 145a and 145b are depicted. However, embodiments are possible in which the processing device 350 has yet more types of cores. Thus, in such other embodiments, the control routine 140 may incorporate yet more compilers as needed to generate compiled versions of at least the instruction block 175 for execution by those additional types of cores.

The control routine 140 may include an analyzer component 147 executable by the processor component 150 to analyze the characteristics of the instructions making up at least the instruction block 175, and generate the characteristics data 337 providing indications of those characteristics. As previously discussed, the characteristics indicated in the characteristics data 337 may include statistics such as a proportion of the instructions within the instruction block 175 that are memory access instructions and/or a proportion of the instructions within the instruction block 175 that are branch instructions.

Turning more specifically to FIG. 5, the control routine 340 may include a policy component 341 executable by the processor component 350 to monitor a sensor 310 and update an indication of a selection of energy policy of the policy data 331 in response to a change in conditions detected by the sensor 310. As previously discussed, the energy policy is a selected balance between time required to execute an instance of the instruction block 375a or 375b (each of which is a compiled version of the instruction block 175, and implements the same logic) and electric power consumed in executing that instance. Again, the selection of such a balance (e.g., the selection of an energy policy) may be expressed in the policy data 331 in a numerical value in the range of 0 to 1.

The control routine 340 may include a core selection component 345 executable by the processor component 350 to select types of cores from among the types of cores 355a and 355b of the processor component 350 to execute the instruction blocks 375a and/or 375b, respectively. Stated differently, the core selection component 345 selects the types of cores 355a and/or 355b to perform the logic of the instruction block 175 (from which the instruction blocks 375a and 375b are compiled). Again, during an initial execution of the application routine 370, the core selection component 345 may rely on indications of characteristics of the instructions of the instruction block 175 to determine which type(s) of processor cores to select. During subsequent executions of the application routine 370, in various embodiments, the core selection component 345 may rely on various combinations of the characteristics data 337, indications of characteristics of previous executions of the execution database 334 and the indication of an energy policy of the policy data 331.

The control routine 340 may include a monitoring component 343 executable by the processor component 350 to operate the monitoring unit 353 of the processor component 350 to monitor execution of instances of one or both of the instruction blocks 375a and 375b by the cores 355a and 355b, respectively. The monitoring component 343 further stores indications of observed characteristics of the execution of those instances in the execution database 334. As previously discussed, separate entries are formed in the execution database 334 for the execution of instances of each instruction block of each routine executed. Further, one or more of those entries may be divided into further entries in which characteristics of the execution of instances under differing conditions are stored.

Turning more specifically to FIG. 6, the alternate embodiment of the computing device 300 depicted therein is substantially similar to the embodiment of the computing device 300 depicted in FIG. 5, with the exception that the processor component 350 of the alternate embodiment of FIG. 6 additionally compiles the instruction code 170. Therefore, the control routine 340 of the alternate embodiment of the computing device 300 of FIG. 6 may additionally include one or more of the compilers 145a and 145b, and the analyzer component 147.

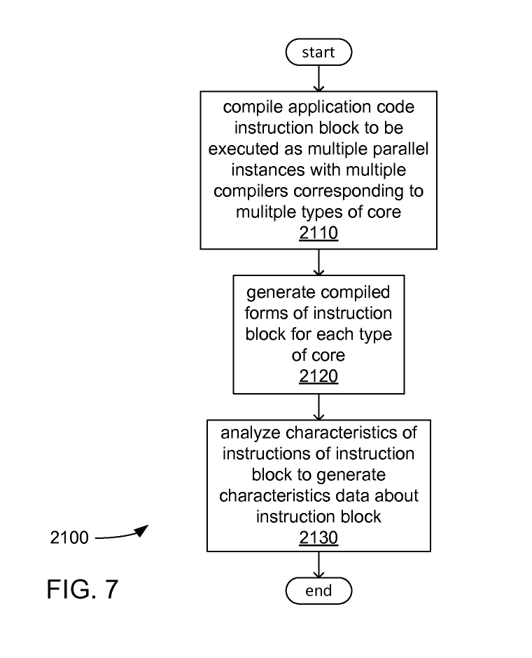

FIG. 7 illustrates one embodiment of a logic flow 2100. The logic flow 2100 may be representative of some or all of the operations executed by one or more embodiments described herein. More specifically, the logic flow 2100 may illustrate operations performed by the processor component 150 in executing at least the control routine 140, and/or performed by other component(s) of the compiling device 100.

At 2110, a processor component of a compiling device of a heterogeneous core processing system (e.g., the processor component 150 of the compiling device 100 of the heterogeneous core processing 1000) compiles at least an instruction block of application code, where the instruction block is meant to be executed as multiple instances in parallel. In compiling at least the instruction block, multiple compilers are used, each compiler corresponding to a different type of core of multiple types of core. This compiling of the instruction block results in the generation of multiple compiled forms of the instruction block at 2120, each corresponding to a different type of the multiple types of core. As previously discussed, these different compiled forms of the instruction block may be combined into a single application routine generated by the compiling of the application code.

At 2130, characteristics of the instructions making up the instruction block are analyzed and a characteristics data that includes indications of those characteristics is generated. As previously discussed, such characteristics may include statistical data of the types of instructions making up the instruction block, such as and not limited to, one or more ratios of particular types of instructions (e.g., memory access instructions, branch instructions, etc.) to the total quantity of instructions within the instruction block.

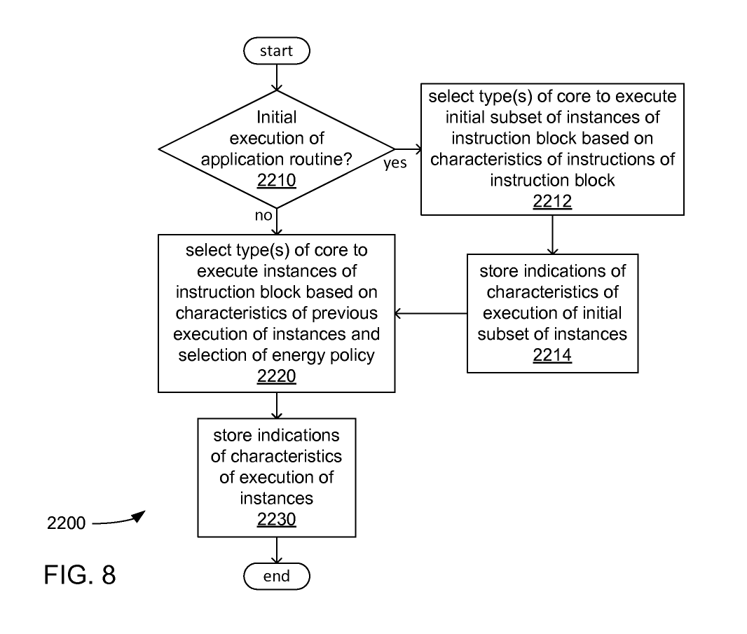

FIG. 8 illustrates one embodiment of a logic flow 2200. The logic flow 2200 may be representative of some or all of the operations executed by one or more embodiments described herein. More specifically, the logic flow 2200 may illustrate operations performed by the processor component 350 in executing at least the control routine 340, and/or performed by other component(s) of the computing device 300.

At 2210, a processor component of a computing device (e.g., the processor component 350 of the computing device 300 of the heterogeneous core processing system 1000) checks whether an execution of an application routine is an initial execution such that an execution database would not have entries indicating characteristics of execution of an instruction block of the application routine. As previously discussed, entries in the execution database are generated and/or their indications of characteristics of execution are refined from observed characteristics of execution of instances of instruction blocks.

If the execution of the application routine is not an initial execution, then at 2220, one or more types of core are selected to execute instances of an instruction block of the application routine based on indications stored in the execution database of characteristics of execution of that instruction block occurring during previous executions of the application routine. As previously discussed, the selection of types of cores may also be based on a selection of a balance between time required to execute an instance of the instruction block and power consumed to do so (e.g., a selection of an energy policy).

However, if the execution of the application routine is an initial execution, then at 2212, one or more types of core are selected to execute an initial subset of instances of the instruction block of the application routine based on characteristics of the instructions making up the instruction block observed during compiling of the instruction block. And at 2214, indications of characteristics of execution of that initial subset of instances are stored in the execution database as a new entry. That new entry is then used to provide indications of characteristics of execution at 2220. Regardless of whether the execution of the application routine is an initial execution, or not, indications of characteristics of execution of instances of the instruction block at 2220 are stored in the execution database at 2230.

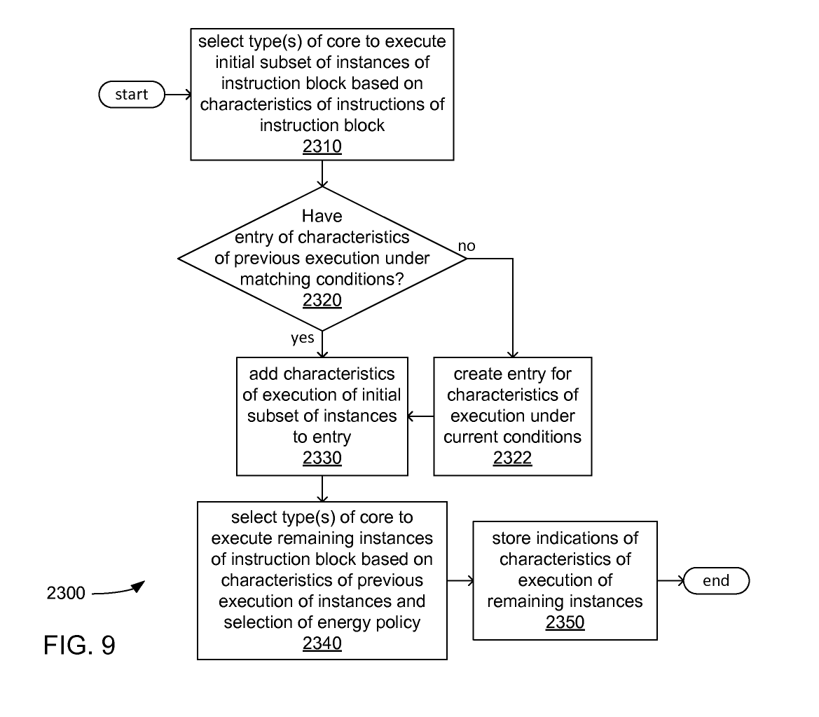

FIG. 9 illustrates one embodiment of a logic flow 2300. The logic flow 2300 may be representative of some or all of the operations executed by one or more embodiments described herein. More specifically, the logic flow 2300 may illustrate operations performed by the processor component 350 in executing at least the control routine 340, and/or performed by other component(s) of the computing device 300.

At 2310, a processor component of a computing device (e.g., the processor component 350 of the computing device 300 of the heterogeneous core processing system 1000) selects one or more types of core to execute an initial subset of instances of an instruction block based on characteristics of the instructions making up the instruction block observed during compiling of the instruction block. As previously discussed, this may provide an opportunity to determine aspects of current conditions under which instances of the instruction block are being executed.

At 2320, an execution database is searched for an entry of characteristics of execution of the instruction block occurring during a previous execution of an application routine that includes the instruction block where that entry is associated with conditions that match the current conditions. As previously discussed, pertinent aspects of the conditions may include, but are not limited to, a selection of energy policy, characteristics of data and/or other inputs to whatever process is performed by at least the instruction block of the application routine, or an observed behavior in which conditional branches associated with the instruction block or taken. As also previously discussed, there may be a selected threshold of a degree of difference of conditions that is employed to determine whether the conditions associated with an entry match the current conditions.

If such an entry is found, then at 2330, the characteristics of execution of the initial subset of instances are added to the characteristics indicated in the entry. As previously discussed, the characteristics of execution may include one or more running averages, and the addition of new data from the execution of new instances may be averaged into such running averages with weighting to bias the averages towards the new data. However, if such an entry is not found, then at 2322, a new entry is created in the execution database, and indications of the characteristics of execution of the initial subset and indications of the current conditions are added to that new entry at 2330.

At 2340, one or more types of core are selected to execute the remaining instances of the instruction block based on the indications stored in the execution database (either in the entry that was found or the entry that was just created) of characteristics of execution of that instruction block occurring during previous executions of the application routine. As previously discussed, the selection of types of cores may also be based on a selection of a balance between time required to execute an instance of the instruction block and power consumed to do so (e.g., a selection of an energy policy). Characteristics of execution of instances of the instruction block at 2340 are then stored in the execution database at 2350.

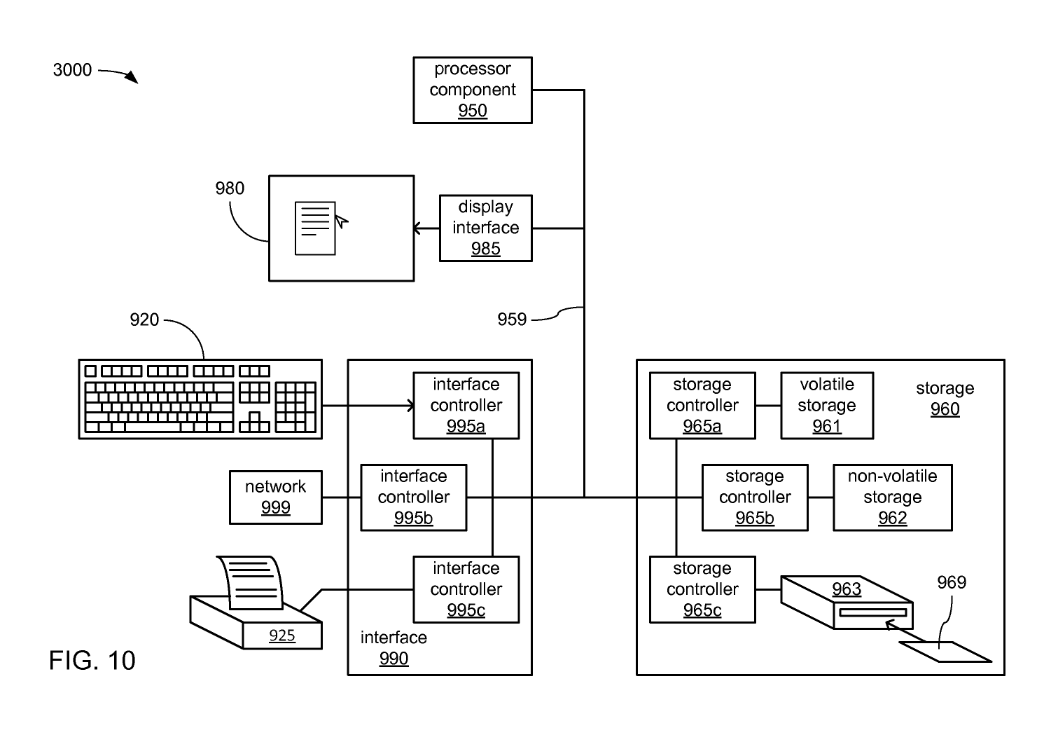

FIG. 10 illustrates an embodiment of a processing architecture 3000 suitable for implementing various embodiments as previously described. More specifically, the processing architecture 3000 (or variants thereof) may be implemented as part of one or more of the computing devices 100, 300 or 500. It should be noted that components of the processing architecture 3000 are given reference numbers in which the last two digits correspond to the last two digits of reference numbers of at least some of the components earlier depicted and described as part of these computing devices. This is done as an aid to correlating components of each.

The processing architecture 3000 may include various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor component, the processor component itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. A message (including a command, status, address or data message) may be one of such signals or may be a plurality of such signals, and may be transmitted either serially or substantially in parallel through any of a variety of connections and/or interfaces.

As depicted, in implementing the processing architecture 3000, a computing device may include at least a processor component 950, a storage 960, an interface 990 to other devices, and a coupling 959. As will be explained, depending on various aspects of a computing device implementing the processing architecture 3000, including its intended use and/or conditions of use, such a computing device may further include additional components, such as without limitation, a display interface 985, or one or more processing subsystems 900.

The coupling 959 may include one or more buses, point-to-point interconnects, transceivers, buffers, crosspoint switches, and/or other conductors and/or logic that communicatively couples at least the processor component 950 to the storage 960. Coupling 959 may further couple the processor component 950 to one or more of the interface 990, the audio subsystem 970 and the display interface 985 (depending on which of these and/or other components are also present). With the processor component 950 being so coupled by couplings 959, the processor component 950 is able to perform the various ones of the tasks described at length, above, for whichever one(s) of the aforedescribed computing devices implement the processing architecture 3000. Coupling 959 may be implemented with any of a variety of technologies or combinations of technologies by which signals are optically and/or electrically conveyed. Further, at least portions of couplings 959 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor component 950 (corresponding to one or more of the processor components 150, 350 or 550) may include any of a wide variety of commercially available processors, employing any of a wide variety of technologies and implemented with one or more cores physically combined in any of a number of ways.

As previously discussed, the storage 960 (corresponding to one or more of the storages 160, 360 or 560) may be made up of one or more distinct storage devices based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly including multiple distinct types of storage is in recognition of the commonplace use of more than one type of storage device in computing devices in which one type provides relatively rapid reading and writing capabilities enabling more rapid manipulation of data by the processor component 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 959 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 959 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of machine-readable storage medium 969, the removable media storage 963 may be communicatively coupled to coupling 959 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969.

One or the other of the volatile storage 961 or the non-volatile storage 962 may include an article of manufacture in the form of a machine-readable storage media on which a routine including a sequence of instructions executable by the processor component 950 to implement various embodiments may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data. Thus, a routine including a sequence of instructions to be executed by the processor component 950 to implement various embodiments may initially be stored on the machine-readable storage medium 969, and the removable media storage 963 may be subsequently employed in copying that routine to the non-volatile storage 962 for longer term storage not requiring the continuing presence of the machine-readable storage medium 969 and/or the volatile storage 961 to enable more rapid access by the processor component 950 as that routine is executed.

As previously discussed, the interface 990 (corresponding to one or more of the interfaces 190, 390 or 590) may employ any of a variety of signaling technologies corresponding to any of a variety of communications technologies that may be employed to communicatively couple a computing device to one or more other devices. Again, one or both of various forms of wired or wireless signaling may be employed to enable the processor component 950 to interact with input/output devices (e.g., the depicted example keyboard 920 or printer 925) and/or other computing devices, possibly through a network (e.g., the network 999) or an interconnected set of networks. In recognition of the often greatly different character of multiple types of signaling and/or protocols that must often be supported by any one computing device, the interface 990 is depicted as including multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999 (perhaps a network made up of one or more links, smaller networks, or perhaps the Internet). The interface 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, a camera or camera array to monitor movement of persons to accept commands and/or data signaled by those persons via gestures and/or facial expressions, laser printers, inkjet printers, mechanical robots, milling machines, etc.

Where a computing device is communicatively coupled to (or perhaps, actually incorporates) a display (e.g., the depicted example display 980, corresponding to the display 580), such a computing device implementing the processing architecture 3000 may also include the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

More generally, the various elements of the computing devices described and depicted herein may include various hardware elements, software elements, or a combination of both. Examples of hardware elements may include devices, logic devices, components, processors, microprocessors, circuits, processor components, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

In Example 1, an apparatus to select types of cores includes a processor component; a core selection component for execution by the processor component to select a core of multiple cores to execute an initial subset of multiple instances of an instruction block in parallel based on characteristics of instructions of the instruction block, and to select a core of the multiple cores to execute remaining instances of the multiple instances of the instruction block in parallel based on characteristics of execution of the initial subset stored in an execution database; and a monitoring component for execution by the processor component to record the characteristics of execution of the initial subset in the execution database.

In Example 2, which includes the subject matter of Example 1, the processor component may include a monitoring unit to monitor characteristics of execution of the multiple instances by at least one core of the multiple cores, the monitoring component to operate the monitoring unit to monitor the characteristics of execution of the initial subset.

In Example 3, which includes the subject matter of any of Examples 1-2, the core selection component may select the core to execute the remaining instances based on the characteristics of execution of the initial subset and on a selected balance between time to execute an instance of the multiple instances and electric power consumed to execute the instance.

In Example 4, which includes the subject matter of any of Examples 1-3, the apparatus may include a policy component to alter the selected balance based on a change in conditions under which an instance of the multiple instances is executed, the conditions comprising availability of AC mains electric power or a level of available electric power stored in a battery.

In Example 5, which includes the subject matter of any of Examples 1-4, the characteristics of the instructions of the instruction block may include a ratio of memory access instructions to a total quantity of instructions of the instruction block or a ratio of branch instructions to the total quantity of instructions of the instruction block.

In Example 6, which includes the subject matter of any of Examples 1-5, the characteristics of execution may include an amount of time to execute an instance of the initial subset of multiple instances or an amount of electric power consumed to execute the instance.

In Example 7, which includes the subject matter of any of Examples 1-6, the core selection component may search the execution database for an entry comprising an indication of characteristics of execution of instances of the instruction block associated with conditions under which the execution of the instances occurred, and to add an indication of characteristics of execution of the initial subset to the entry based on the conditions associated with the entry matching the conditions under which execution of the initial subset occurred within a selected threshold.

In Example 8, which includes the subject matter of any of Examples 1-7, the apparatus may include an interface to receive characteristics data comprising an indication of the characteristics of the instructions of the instruction block.

In Example 9, which includes the subject matter of any of Examples 1-8, the apparatus may include a first compiler for execution by the processor component to compile the instruction block for execution by a first core of the multiple cores, a second compiler for execution by the processor component to compile the instruction block for execution by a second core of the multiple cores, and an analyzer component to analyze the instructions of the instruction block to determine the characteristics of the instructions of the instruction block.

In Example 10, which includes the subject matter of any of Examples 1-9, the apparatus may include the multiple cores.

In Example 11, an apparatus to enable selection of types of cores includes a processor component; a first compiler and a second compiler for execution by the processor component to compile an application code to generate an application routine, the first compiler to compile an instruction block of the application code to generate a first instruction block of the application routine for execution by a first core, the second compiler to compile the instruction block of the application code to generate a second instruction block of the application routine for execution by a second core; and an analyzer component to analyze instructions of the instruction block of the application code to determine characteristics of the instructions of the instruction block.

In Example 12, which includes the subject matter of Example 11, the apparatus may include a core selection component for execution by the processor component to select the first core or the second core to execute an initial subset of multiple instances of the instruction block of the application code based on the characteristics of the instructions, and to select the first core or the second core to execute remaining instances of the multiple instances based on characteristics of execution of the initial subset stored in an execution database; and a monitoring component for execution by the processor component to record the characteristics of execution of the initial subset in the execution database.

In Example 13, which includes the subject matter of any of Examples 11-12, selection of the first core to execute instances of the instruction block of the application code may include selection of the first instruction block for execution by the first core, and selection of the second core to execute instances of the instruction block of the application code may include selection of the second instruction block for execution by the second core.

In Example 14, which includes the subject matter of any of Examples 11-13, the core selection component may select the first core or the second to execute the remaining instances based on the characteristics of execution of the initial subset and on a selected balance between time to execute an instance of the multiple instances and electric power consumed to execute the instance.

In Example 15, which includes the subject matter of any of Examples 11-14, the apparatus may include a policy component to alter the selected balance based on a change in conditions under which an instance of the multiple instances is executed, the conditions comprising availability of AC mains electric power or a level of available electric power stored in a battery.

In Example 16, which includes the subject matter of any of Examples 11-15, the apparatus may include interface to transmit characteristics data comprising an indication of the characteristics of the instructions of the instruction block and the application routine to a computing device.

In Example 17, which includes the subject matter of any of Examples 11-16, the processor component may include the first core and the second core.

In Example 18, a computer-implemented method for selecting types of cores includes selecting a core of multiple cores to execute an initial subset of multiple instances of an instruction block in parallel based on characteristics of instructions of the instruction block, selecting a core of the multiple cores to execute remaining instances of the multiple instances of the instruction block in parallel based on characteristics of execution of the initial subset stored in an execution database, and recording the characteristics of execution of the initial subset in the execution database.

In Example 19, which includes the subject matter of Example 18, the method may include selecting the core to execute the remaining instances based on the characteristics of execution of the initial subset and on a selected balance between time to execute an instance of the multiple instances and electric power consumed to execute the instance.

In Example 20, which includes the subject matter of any of Examples 18-19, the method may include altering the selected balance based on a change in conditions under which an instance of the multiple instances is executed, the conditions comprising availability of AC mains electric power or a level of available electric power stored in a battery.

In Example 21, which includes the subject matter of any of Examples 18-20, the characteristics of the instructions of the instruction block may include a ratio of memory access instructions to a total quantity of instructions of the instruction block or a ratio of branch instructions to the total quantity of instructions of the instruction block.

In Example 22, which includes the subject matter of any of Examples 18-21, the characteristics of execution may include an amount of time to execute an instance of the initial subset of multiple instances or an amount of electric power consumed to execute the instance.

In Example 23, which includes the subject matter of any of Examples 18-22, the method may include searching the execution database for a first entry comprising an indication of characteristics of execution of instances of the instruction block associated with conditions under which the execution of the instances occurred, and adding an indication of characteristics of execution of the initial subset to the first entry based on the conditions associated with the first entry matching the conditions under which execution of the initial subset occurred within a selected threshold.

In Example 24, which includes the subject matter of any of Examples 18-23, the method may include adding a second entry comprising an indication of the characteristics of execution of the initial subset associated the conditions under which execution of the initial subset occurred based on the conditions associated with the first entry not matching the conditions under which execution of the initial subset occurred within the selected threshold.

In Example 25, which includes the subject matter of any of Examples 18-24, the method may include receiving characteristics data comprising an indication of the characteristics of the instructions of the instruction block from a network.

In Example 26, which includes the subject matter of any of Examples 18-25, the method may include compiling the instruction block for execution by a first core of the multiple cores, compiling the instruction block for execution by a second core of the multiple cores, and analyzing the instructions of the instruction block to determine the characteristics of the instructions of the instruction block.

In Example 27, at least one machine-readable storage medium may include instructions that when executed by a computing device, cause the computing device to select a core of multiple cores to execute an initial subset of multiple instances of an instruction block in parallel based on characteristics of instructions of the instruction block, select a core of the multiple cores to execute remaining instances of the multiple instances of the instruction block in parallel based on characteristics of execution of the initial subset stored in an execution database, and record the characteristics of execution of the initial subset in the execution database.

In Example 28, which includes the subject matter of Example 27, the computing device may be caused to select the core to execute the remaining instances based on the characteristics of execution of the initial subset and on a selected balance between time to execute an instance of the multiple instances and electric power consumed to execute the instance.

In Example 29, which includes the subject matter of any of Examples 27-28, the computing device may be caused to alter the selected balance based on a change in conditions under which an instance of the multiple instances is executed, the conditions comprising availability of AC mains electric power or a level of available electric power stored in a battery.

In Example 30, which includes the subject matter of any of Examples 27-29, the characteristics of the instructions of the instruction block may include a ratio of memory access instructions to a total quantity of instructions of the instruction block or a ratio of branch instructions to the total quantity of instructions of the instruction block.

In Example 31, which includes the subject matter of any of Examples 27-30, the characteristics of execution may include an amount of time to execute an instance of the initial subset of multiple instances or an amount of electric power consumed to execute the instance.

In Example 32, which includes the subject matter of any of Examples 27-31, the computing device may be caused to search the execution database for a first entry comprising an indication of characteristics of execution of instances of the instruction block associated with conditions under which the execution of the instances occurred, and add an indication of characteristics of execution of the initial subset to the first entry based on the conditions associated with the first entry matching the conditions under which execution of the initial subset occurred within a selected threshold.

In Example 33, which includes the subject matter of any of Examples 27-32, the computing device may be caused to add a second entry comprising an indication of the characteristics of execution of the initial subset associated the conditions under which execution of the initial subset occurred based on the conditions associated with the first entry not matching the conditions under which execution of the initial subset occurred within the selected threshold.

In Example 34, which includes the subject matter of any of Examples 27-33, the computing device may be caused to receive characteristics data comprising an indication of the characteristics of the instructions of the instruction block from a network.

In Example 35, which includes the subject matter of any of Examples 27-34, the computing device may be caused to compile the instruction block for execution by a first core of the multiple cores, compile the instruction block for execution by a second core of the multiple cores, and analyze the instructions of the instruction block to determine the characteristics of the instructions of the instruction block.

In Example 36, an apparatus to select types of cores includes means for selecting a core of multiple cores to execute an initial subset of multiple instances of an instruction block in parallel based on characteristics of instructions of the instruction block, selecting a core of the multiple cores to execute remaining instances of the multiple instances of the instruction block in parallel based on characteristics of execution of the initial subset stored in an execution database, and recording the characteristics of execution of the initial subset in the execution database.

In Example 37, which includes the subject matter of Example 36, the apparatus may include means for selecting the core to execute the remaining instances based on the characteristics of execution of the initial subset and on a selected balance between time to execute an instance of the multiple instances and electric power consumed to execute the instance.

In Example 38, which includes the subject matter of any of Examples 36-37, apparatus may include means for altering the selected balance based on a change in conditions under which an instance of the multiple instances is executed, the conditions comprising availability of AC mains electric power or a level of available electric power stored in a battery.

In Example 39, which includes the subject matter of any of Examples 36-38, the characteristics of the instructions of the instruction block may include a ratio of memory access instructions to a total quantity of instructions of the instruction block or a ratio of branch instructions to the total quantity of instructions of the instruction block.

In Example 40, which includes the subject matter of any of Examples 36-39, the characteristics of execution may include an amount of time to execute an instance of the initial subset of multiple instances or an amount of electric power consumed to execute the instance.

In Example 41, which includes the subject matter of any of Examples 36-40, the apparatus may include means for searching the execution database for a first entry comprising an indication of characteristics of execution of instances of the instruction block associated with conditions under which the execution of the instances occurred, and adding an indication of characteristics of execution of the initial subset to the first entry based on the conditions associated with the first entry matching the conditions under which execution of the initial subset occurred within a selected threshold.

In Example 42, which includes the subject matter of any of Examples 36-41, the apparatus may include means for adding a second entry comprising an indication of the characteristics of execution of the initial subset associated the conditions under which execution of the initial subset occurred based on the conditions associated with the first entry not matching the conditions under which execution of the initial subset occurred within the selected threshold.

In Example 43, which includes the subject matter of any of Examples 36-42, the apparatus may include means for receiving characteristics data comprising an indication of the characteristics of the instructions of the instruction block from a network.

In Example 44, which includes the subject matter of any of Examples 36-43, the apparatus may include means for compiling the instruction block for execution by a first core of the multiple cores, compiling the instruction block for execution by a second core of the multiple cores, and analyzing the instructions of the instruction block to determine the characteristics of the instructions of the instruction block.

In Example 45, at least one machine-readable storage medium may include instructions that when executed by a computing device, cause the computing device to perform any of the above.

In Example 46, an apparatus to assign processor component cores to perform task portions may include means for performing any of the above.

1-25. (canceled)

26. An apparatus to select types of cores comprising:
a processor component;
a core selection component for execution by the processor component to select a core of multiple cores to execute an initial subset of multiple instances of an instruction block in parallel based on characteristics of instructions of the instruction block, and to select a core of the multiple cores to execute remaining instances of the multiple instances of the instruction block in parallel based on characteristics of execution of the initial subset stored in an execution database; and
a monitoring component for execution by the processor component to record the characteristics of execution of the initial subset in the execution database.

27. The apparatus of claim 26, the processor component comprising a monitoring unit to monitor characteristics of execution of the multiple instances by at least one core of the multiple cores, the monitoring component to operate the monitoring unit to monitor the characteristics of execution of the initial subset.

28. The apparatus of claim 26, the core selection component to select the core to execute the remaining instances based on the characteristics of execution of the initial subset and on a selected balance between time to execute an instance of the multiple instances and electric power consumed to execute the instance.

29. The apparatus of claim 28, comprising a policy component to alter the selected balance based on a change in conditions under which an instance of the multiple instances is executed, the conditions comprising availability of AC mains electric power or a level of available electric power stored in a battery.

30. The apparatus of claim 26, the core selection component to search the execution database for an entry comprising an indication of characteristics of execution of instances of the instruction block associated with conditions under which the execution of the instances occurred, and to add an indication of characteristics of execution of the initial subset to the entry based on the conditions associated with the entry matching the conditions under which execution of the initial subset occurred within a selected threshold.

31. The apparatus of claim 26, comprising:
a first compiler for execution by the processor component to compile the instruction block for execution by a first core of the multiple cores;
a second compiler for execution by the processor component to compile the instruction block for execution by a second core of the multiple cores; and
an analyzer component to analyze the instructions of the instruction block to determine the characteristics of the instructions of the instruction block.

32. The apparatus of claim 26, comprising an interface to receive characteristics data comprising an indication of the characteristics of the instructions of the instruction block.

33. An apparatus to enable selection of types of cores comprising:
a processor component;
a first compiler and a second compiler for execution by the processor component to compile an application code to generate an application routine, the first compiler to compile an instruction block of the application code to generate a first instruction block of the application routine for execution by a first core, the second compiler to compile the instruction block of the application code to generate a second instruction block of the application routine for execution by a second core; and
an analyzer component to analyze instructions of the instruction block of the application code to determine characteristics of the instructions of the instruction block.

34. The apparatus of claim 33, comprising:
a core selection component for execution by the processor component to select the first core or the second core to execute an initial subset of multiple instances of the instruction block of the application code based on the characteristics of the instructions, and to select the first core or the second core to execute remaining instances of the multiple instances based on characteristics of execution of the initial subset stored in an execution database; and
a monitoring component for execution by the processor component to record the characteristics of execution of the initial subset in the execution database.

35. The apparatus of claim 34, selection of the first core to execute instances of the instruction block of the application code comprises selection of the first instruction block for execution by the first core, and selection of the second core to execute instances of the instruction block of the application code comprises selection of the second instruction block for execution by the second core.

36. The apparatus of claim 34, the core selection component to select the first core or the second to execute the remaining instances based on the characteristics of execution of the initial subset and on a selected balance between time to execute an instance of the multiple instances and electric power consumed to execute the instance.

37. The apparatus of claim 36, comprising a policy component to alter the selected balance based on a change in conditions under which an instance of the multiple instances is executed, the conditions comprising availability of AC mains electric power or a level of available electric power stored in a battery.

38. The apparatus of claim 33, the processor component comprising the first core and the second core.

39. A computing-implemented method for selecting types of cores comprising:
selecting a core of multiple cores to execute an initial subset of multiple instances of an instruction block in parallel based on characteristics of instructions of the instruction block;
selecting a core of the multiple cores to execute remaining instances of the multiple instances of the instruction block in parallel based on characteristics of execution of the initial subset stored in an execution database; and
recording the characteristics of execution of the initial subset in the execution database.

40. The computer-implemented method of claim 39, comprising selecting the core to execute the remaining instances based on the characteristics of execution of the initial subset and on a selected balance between time to execute an instance of the multiple instances and electric power consumed to execute the instance.

41. The computer-implemented method of claim 40, comprising altering the selected balance based on a change in conditions under which an instance of the multiple instances is executed, the conditions comprising availability of AC mains electric power or a level of available electric power stored in a battery.

42. The computer-implemented method of claim 39, comprising:
searching the execution database for a first entry comprising an indication of characteristics of execution of instances of the instruction block associated with conditions under which the execution of the instances occurred; and
adding an indication of characteristics of execution of the initial subset to the first entry based on the conditions associated with the first entry matching the conditions under which execution of the initial subset occurred within a selected threshold.

43. The computer-implemented method of claim 42, comprising adding a second entry comprising an indication of the characteristics of execution of the initial subset associated the conditions under which execution of the initial subset occurred based on the conditions associated with the first entry not matching the conditions under which execution of the initial subset occurred within the selected threshold.

44. The computer-implemented method of claim 39, comprising:
compiling the instruction block for execution by a first core of the multiple cores;
compiling the instruction block for execution by a second core of the multiple cores; and
analyzing the instructions of the instruction block to determine the characteristics of the instructions of the instruction block.

45. At least one machine-readable storage medium comprising instructions that when executed by a computing device, cause the computing device to:
select a core of multiple cores to execute an initial subset of multiple instances of an instruction block in parallel based on characteristics of instructions of the instruction block;
select a core of the multiple cores to execute remaining instances of the multiple instances of the instruction block in parallel based on characteristics of execution of the initial subset stored in an execution database; and
record the characteristics of execution of the initial subset in the execution database.

46. The at least one machine-readable storage medium of claim 45, the computing device caused to select the core to execute the remaining instances based on the characteristics of execution of the initial subset and on a selected balance between time to execute an instance of the multiple instances and electric power consumed to execute the instance.

47. The at least one machine-readable storage medium of claim 46, the computing device caused to alter the selected balance based on a change in conditions under which an instance of the multiple instances is executed, the conditions comprising availability of AC mains electric power or a level of available electric power stored in a battery.

48. The at least one machine-readable storage medium of claim 45, the characteristics of the instructions of the instruction block comprising a ratio of memory access instructions to a total quantity of instructions of the instruction block or a ratio of branch instructions to the total quantity of instructions of the instruction block.

49. The at least one machine-readable storage medium of claim 45, the characteristics of execution comprising an amount of time to execute an instance of the initial subset of multiple instances or an amount of electric power consumed to execute the instance.

50. The at least one machine-readable storage medium of claim 45, the computing device caused to:
search the execution database for a first entry comprising an indication of characteristics of execution of instances of the instruction block associated with conditions under which the execution of the instances occurred; and
add an indication of characteristics of execution of the initial subset to the first entry based on the conditions associated with the first entry matching the conditions under which execution of the initial subset occurred within a selected threshold.
